(19) United States
(12) Patent Application Publication
(10) Pub. No.: US 2025/0358549 A1
(43) Pub. Date: Nov. 20, 2025

(54) PATCH PANEL WITH GROUNDING BUMP

(71) Applicant: Leviton Manufacturing Co., Inc., Melville, NY (US)

(72) Inventor: Charles R. Bragg, Bothell, WA (US)

(21) Appl. No.: 18/664,908

(22) Filed: May 15, 2024

(51) Int. Cl. H04Q 1/02; H02G 3/22; H04Q 1/04

(52) U.S. Cl. CPC H04Q 1/025; H02G 3/22; H04Q 1/04

(57) ABSTRACT

A patch panel comprises an exposed raised area or bump behind each patch panel opening that maintains electrical conductivity between the patch panel frame and a housing of a jack while the jack is installed in the opening. During the manufacturing process, this grounding bump can be masked from paint or powder coating so that the bare metal of the bump remains exposed, yielding a raised surface that readily makes conducive contact with the conductive casing of a jack installed in the patch panel opening without the need for an intermediate component that would normally be required to bridge the gap caused by paint or powder coat thickness.

### TECHNICAL FIELD

The disclosed subject matter relates generally to data cable connectivity hardware such as patch panels.

### BACKGROUND

Category cable jacks are often used to terminate category cables and to interface those cables with other terminated cables that plug into the jacks. In some use cases, these jacks are mounted in patch panels and used to establish data connectivity between category cables terminated on the rear of the jack and category cables plugged into the jack's front-facing aperture via the front side of the patch panel.

Some data communication environments, such as data centers and enterprise network facilities, require their data communication systems to be grounded to ensure electrical safety or to mitigate the effects of electrical interference on the cable's data signals, which could otherwise introduce errors in data transmission. Such systems require a robust electrical path between the metal casing or framework of the jack and the metal frame of the patch panel.

The foregoing is merely intended to provide an overview of patch panel design considerations relevant to the solutions described herein. Problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a patch panel in which electrical conductivity between the patch panel frame and a housing of a jack installed in the patch panel is maintained by a raised area or bump formed behind each opening of the patch panel. During the manufacturing process, this grounding bump can be masked from paint or powder coating so that the bare metal of the bump remains exposed, yielding a bare raised surface that readily makes electrical contact with the conductive casing of a jack installed in the patch panel opening without the need for an intermediate component that would otherwise be required to bridge the conductivity gap between the jack and the patch panel caused by paint or powder coat thickness.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a side view of an example jack used to interface two category cables.

FIG. 2 is a partial front view of an example patch panel with a jack installed in one of the patch panel's openings.

FIG. 3a is a top view of an example patch panel.

FIG. 3b is a front view of the example patch panel.

FIG. 3c is a bottom view of the example patch panel.

FIG. 3d is a side view of the example patch panel.

FIG. 4 is a perspective view of the patch panel.

FIG. 5 is a close-up front view of a portion of the patch panel.

FIG. 6 is a close-up perspective view of a portion of the patch panel as seen from the rear of the patch panel.

FIG. 7 is another close-up perspective view of a portion of the patch panel as seen from the rear of the patch panel and from an angle that offers a more pronounced view of the raised bumps.

FIG. 8a is a perspective view of an example jack that can be installed in an opening of the patch panel, showing the top of the jack.

FIG. 8b is another perspective view of the jack showing the bottom of the jack.

FIG. 8c is a side view of the jack.

FIG. 9 is a perspective view of the patch panel as seen from the rear of the patch panel with a jack oriented for installation into one of the patch panel's openings.

FIG. 10 is another perspective view of the patch panel with the jack oriented for installation as seen from below the patch panel.

FIG. 11 is a perspective view of the patch panel as seen from the rear of the patch panel with the jack fully installed in the opening.

FIG. 12 is another perspective view of the patch panel with the jack fully installed as seen from the front of the patch panel.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Some reference numbers used herein to label illustrated components are suffixed with letters to delineate different instances of a same or similar component. In general, if a reference number without an appended letter is used within this disclosure, the descriptions ascribed to the reference number are to be understood to be applicable to all instances of that reference number with or without an appended letter unless described otherwise.

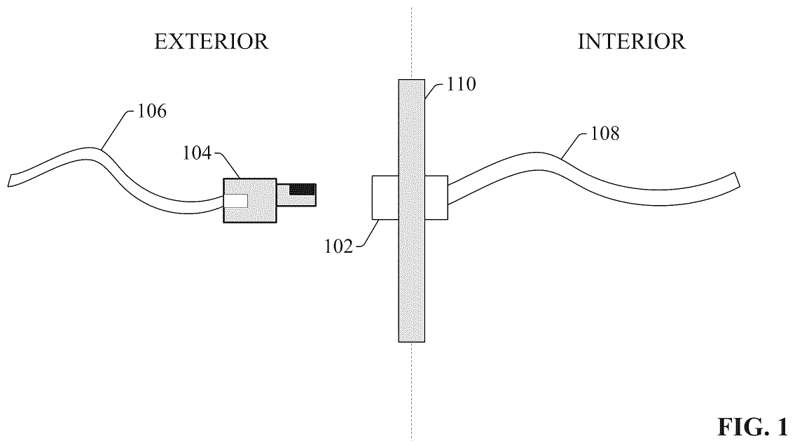

Category cable jacks are often used to terminate category cables, such as shielded twisted pair cables, and to interface those cables with other terminated cables that plug into the jacks. FIG. 1 is a side view of an example jack 102 used to interface two category cables 106 and 108. In an example application, a category cable jack 102 is mounted in a patch panel 110, which itself may be installed on an equipment rack or wall. A data cable 108, such as a shielded twisted pair cable, disposed on the “interior” side of the patch panel 110 is terminated on a rear (or “interior”-facing) side of the jack 102 such that the cable's individual insulated conductors are electrically connected to the conductive contacts or tines within the jack 102. A second category cable 106 disposed on the “exterior” side of the patch panel 110 is terminated with a data plug 104 of the same standard as the jack 102 (e.g., an RJ45 plug), and this plug 104 can be plugged into the “exterior”-facing aperture of the jack 102 to establish electrical coupling, and thus data transmission, between the conductors of cable 106 and the conductors of cable 108.

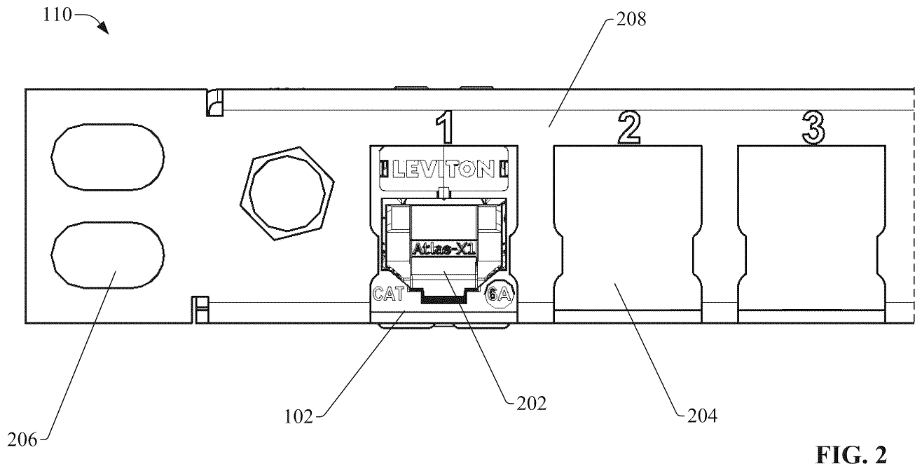

FIG. 2 is a partial front view of an example patch panel 110 with a jack 102 installed in one of the patch panel's openings 204. Patch panel 110 comprises metal (or otherwise electrically conductive) frame, with one or more openings 204 formed through a front-facing, exterior wall 208 of the frame. Jacks 102 can be installed in the respective openings 204 through the rear (or “internal”-facing) side of the patch panel 110, such that the jacks' apertures 202, which are configured to receive a data plug 104 (not shown), face through the front-facing wall 208 of the patch panel 110. Mounting holes 206 are also formed through the patch panel 110 (e.g., near the left and right ends of the front-facing wall 208) so that the patch panel 110 can be mounted to an equipment rack or wall.

Some data communication environments, such as data centers and enterprise network facilities, require their data communication systems to be grounded to ensure electrical safety or to mitigate the effects of electrical interference on the cable's data signals, which could otherwise introduce errors in data transmission. Such systems require a robust electrical path between the metal casing or framework of the jack 102 and the metal frame of the patch panel 110. With the drain wire of the data cable 108 electrically connected to the metal casing of the jack 102, the data cable's shielding will then be grounded via the electrical pathway through the metal casing of the jack 102 and the metal frame of the patch panel 110. The patch panel 110 itself can be grounded via any suitable grounding framework of the equipment rack or wall on which the patch panel 110 is mounted. Typically, a patch panel 110 requires an intermediate cantilever spring mechanism mounted near each of the patch panel's openings 204 in order to complete the conductive path between the patch panel 110 and the jacks 102 installed in the openings 204. This spring mechanism is required to bridge the conductivity gap caused by the layer of paint or powder coat on the patch panel 110. Adding these spring mechanisms to the patch panel design can increase the cost and complexity of the patch panel manufacturing process.

To address these and other issues, one or more embodiments described herein provide a patch panel in which electrical conductivity between the patch panel frame and the jack housing is maintained by an exposed raised area or bump formed behind each opening of the patch panel. During the manufacturing process, this grounding bump can be masked from paint or powder coating so that the bare metal of the bump remains exposed, yielding a raised surface that readily makes conducive contact with the conductive casing of a jack 102 installed in the patch panel opening without the need for an intermediate component that would normally be required to bridge the gap caused by paint or powder coat thickness.

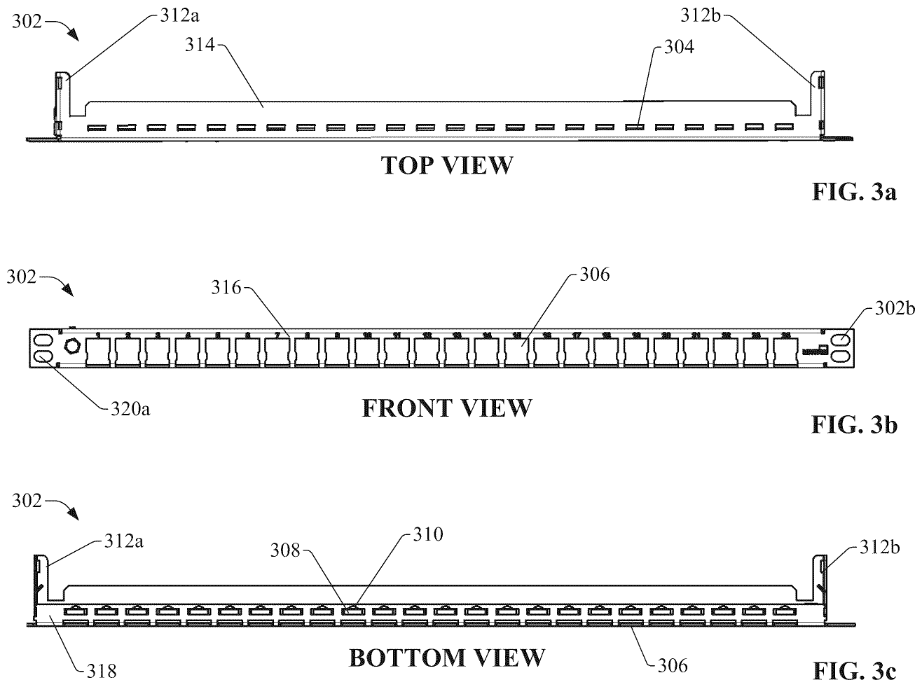

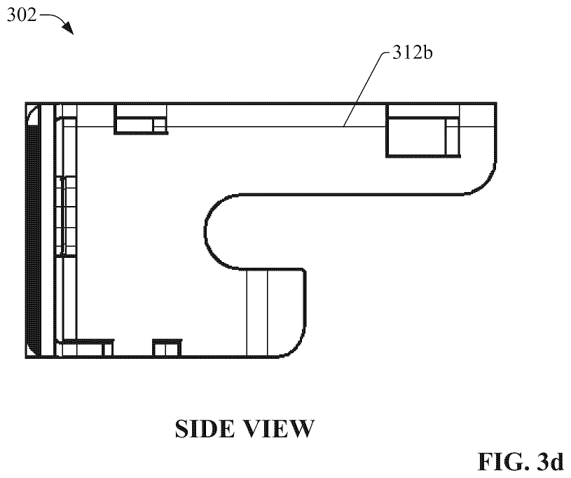

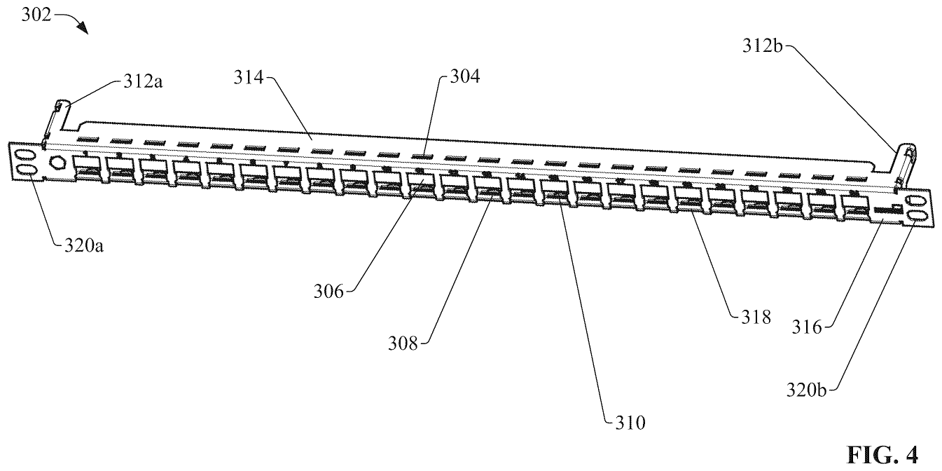

FIGS. 3a-3d are a top view, a front view, a bottom view, and a side view, respectively, of an example patch panel 302 according to one or more embodiments. FIG. 4 is a perspective view of the patch panel 302. Patch panel 302 comprises a metal (or otherwise electrically conductive) frame having a front face 316, a top ridge 314 that extends rearward from the top edge of the front face 316 at a substantially right angle from the front face 316, and a bottom ridge 318 that extends rearward from the bottom edge of the front face 316 at a substantially right angle from the front face 316. Mounting holes 320a and 320b are formed through the front face 316 near respective left and right ends of the front face 316 and can be used to mount the patch panel 302 to an equipment rack or wall. Arms 312a and 312b are also formed near the left and right ends of the patch panel 302 and are directed rearward. These arms 312a, 312b can be used to connect an equipment tray or cable organizing structure to the rear of the patch panel 302.

Openings 306 are formed through the front face 316 of the patch panel 302 and are configured to receive respective jacks 102 (not shown). In the examples illustrated herein, patch panel 302 is a 24-port panel comprising 24 openings 306. However, patch panel 302 can comprise any number of openings 306 without departing from the scope of one or more embodiments.

Upper slots 304 are formed through the top ridge 314, with each upper slot 304 oriented above, and substantially aligned with, a corresponding one of the openings 306. Lower slots 308 are formed through the bottom ridge 318, with each slot oriented below, and substantially aligned with, a corresponding one of the openings 306. Upper slots 304 and lower slots 308 are designed to engage with engagement features on the jacks 102 (not shown) installed in the openings 306, as will be described below.

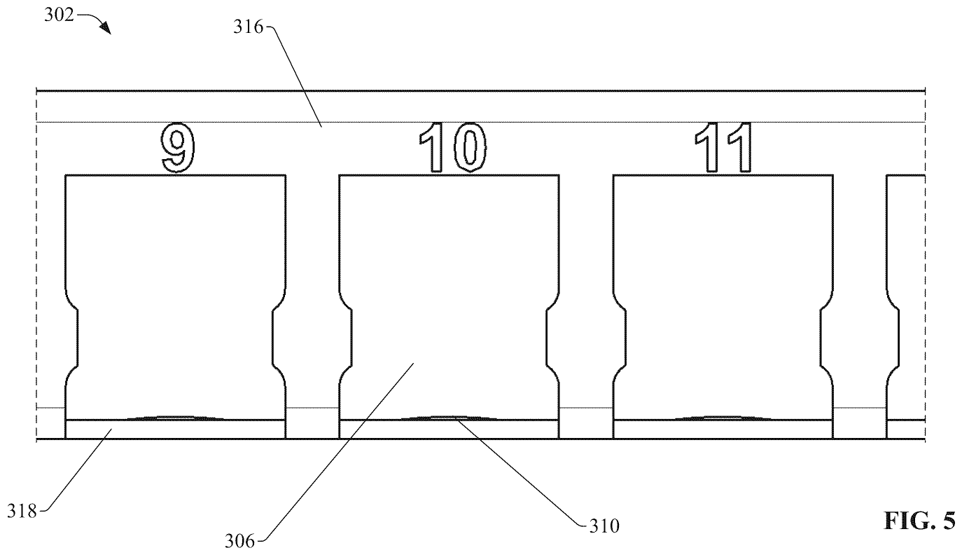

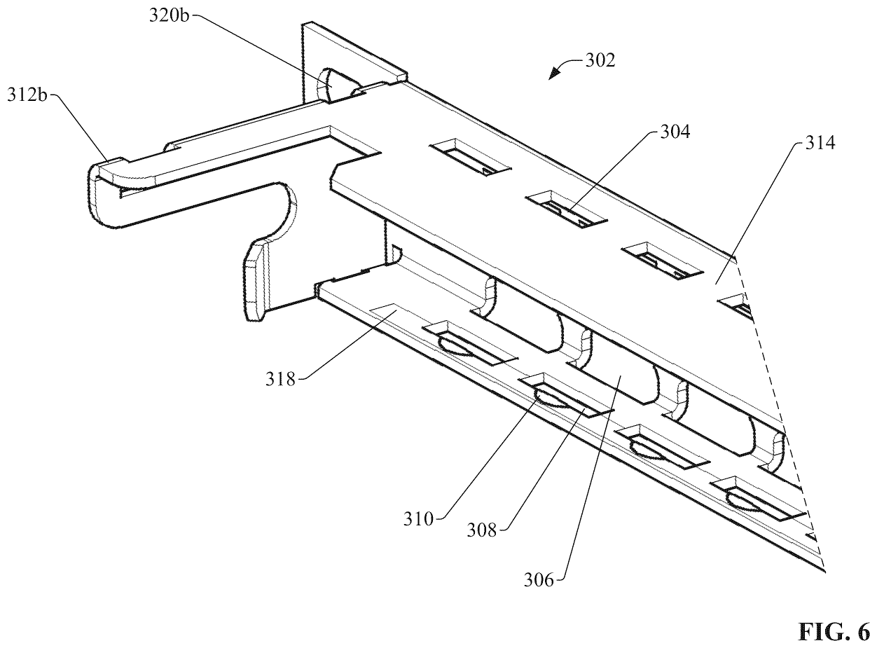

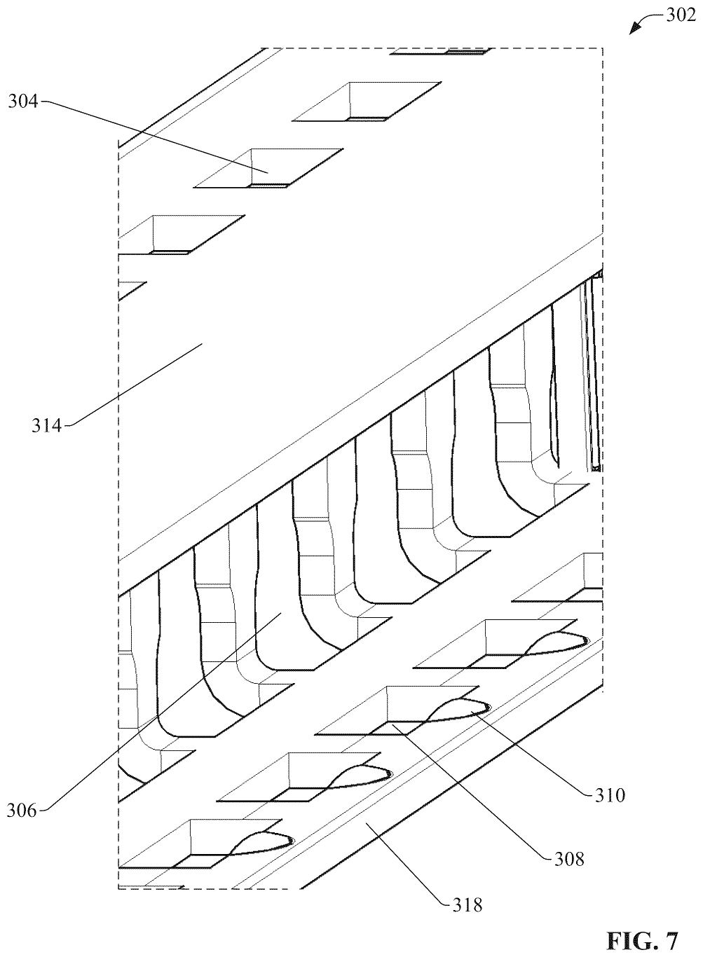

FIG. 5 is a close-up front view of a portion of the patch panel showing the openings 306 in more detail. FIG. 6 is a close-up perspective view of a portion of the patch panel 302 as seen from the rear of the patch panel 302. As noted above, a lower slot 308 is formed through the bottom ridge 318 of the patch panel 302 behind each opening 306, as can be seen in FIG. 6. The length of each lower slot 308 runs substantially parallel with the bottom edge of its corresponding opening 306. A raised bump 310 is formed adjacent to the rear-facing (or “internal”-facing) long edge of each lower slot 308 (that is, the long edge of the lower slot 308 opposite the long edge that faces the opening 306) on the top surface of the bottom ridge 318. The raised bump 310 is substantially centered along the length of its corresponding lower slot 308 in the illustrated examples, but may be oriented anywhere along the length of the lower slot 308 without departing from the scope of one or more embodiments. FIG. 7 is another close-up perspective view of a portion of the patch panel 302 as seen from the rear of the patch panel 302 and from an angle that offers a more pronounced view of the raised bumps 310. Although the examples illustrated herein depict the raised bump 310 as being formed adjacent to the rear-facing long edge of the lower slot 308, the raised bump 310 may instead be formed along the front-facing long edge of the lower slot 308 in some embodiments.

If the patch panel 302 is painted or powder coated as parted of the manufacturing process, each raised bump 310 can be masked during the painting or powder coat process to prevent application of paint or powder coat on the bumps 310, leaving the metal surface of the raised bumps 310 exposed on the finished patch panel 302. Leaving the bare metal of the raised bump 310 exposed in this manner can ensure that contact between the raised bump 310 and the metal casing of a jack 102 installed in the corresponding opening 204 yields a reliable electrical pathway between the jack 102 and the patch panel 302.

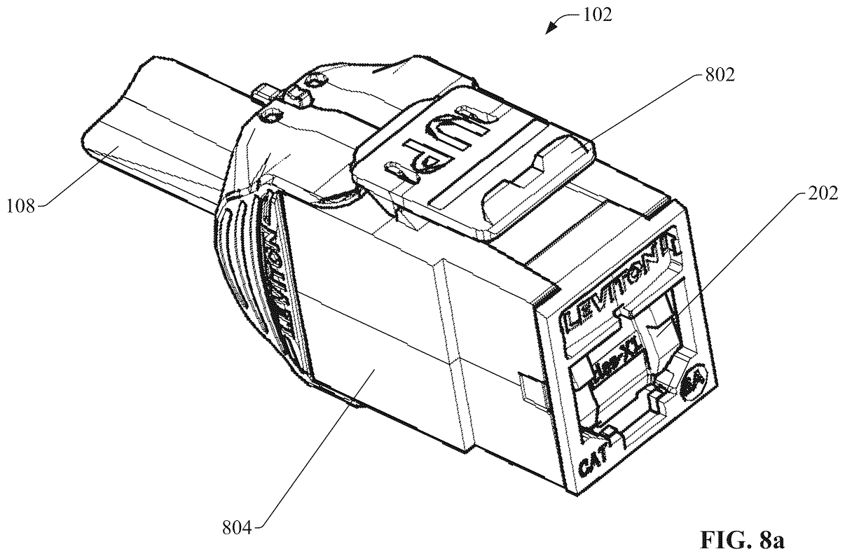

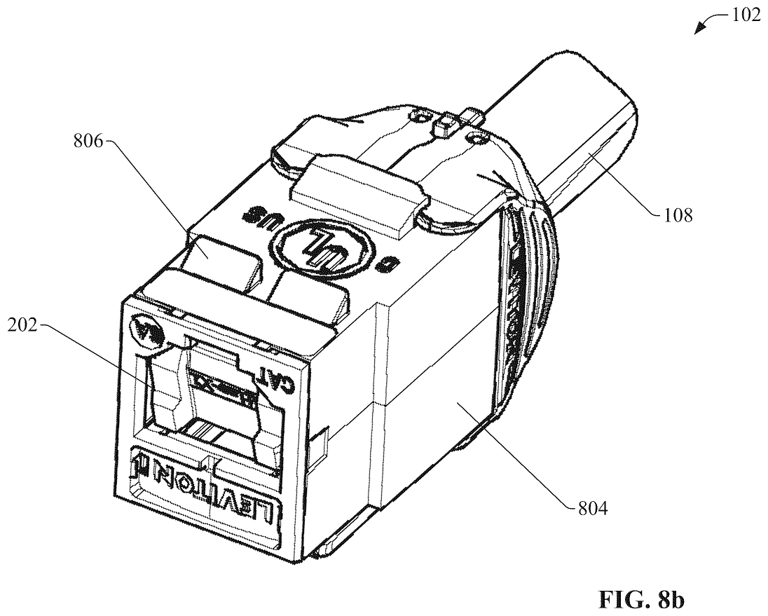

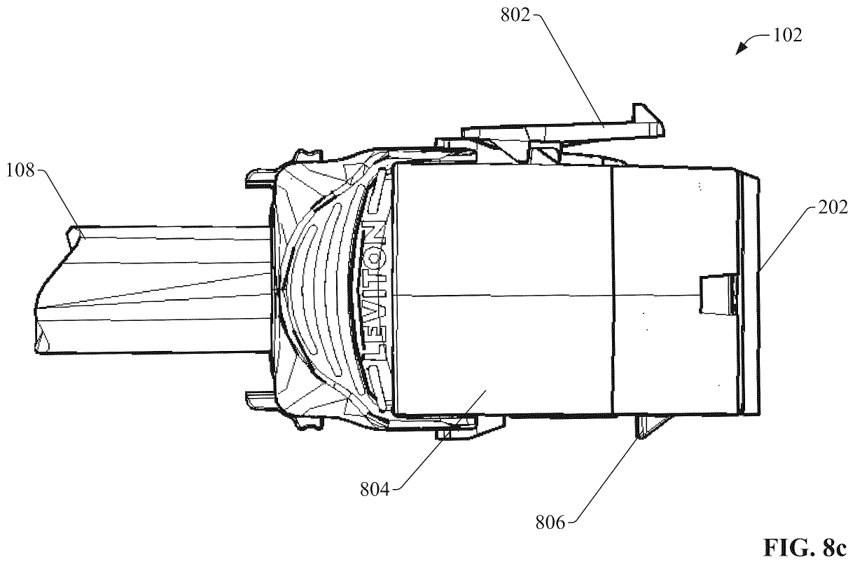

FIG. 8a is a perspective view of an example jack 102 that can be installed in an opening 306 of the patch panel 302, showing the top of the jack 102. FIG. 8b is another perspective view of the jack 102 showing the bottom of the jack 102. FIG. 8c is a side view of the jack 102. Jack 102 comprises a metal jack body 804 with a plug aperture 202 disposed at the front of the jack body 804. The conductive elements (e.g., insulation displacement contacts (IDC)) of jack 102 can be terminated to twisted wire pair conductors exposed at the end of a data cable 108, which is received through the rear side of the jack 102. Individual conductors of the data cable 108 are electrically connected to contacts (e.g., IDC) within the jack body 804 that are electrically coupled to conductive tines that extend into the plug aperture 202. The plug aperture 202 is configured to receive a category cable plug 104 (see FIG. 1) such as a RJ45 plug. When a plug 104 is plugged into the plug aperture 202 of jack 102, the plug's conductive blades interface with the corresponding conductive tines within aperture 202 of jack 102, thus electrically coupling the conductors of the data cable 108 with the conductive blades of the plug 104. In the illustrated example, the plug aperture 202 of jack 102 may be covered by a spring-loaded hinged door or shutter that rests in a closed position while a plug 104 is not inserted into the aperture 202, and that swings to an open position when a plug 104 is inserted. However, some plug designs may omit this plug aperture door or shutter.

As can be seen in FIGS. 8a and 8c, a cantilevered latch 802 is formed on the top side of the jack body 804. As can be seen in FIGS. 8b and 8c, two raised stops 806 are formed on the bottom of the jack body 804 opposite the top side. The latch 802 and stops 806 serve to retain the jack body 804 in an opening 306 of the patch panel 302, by means of engagement with upper slots 304 and lower slots 308, respectively, such that the jack's aperture 202 faces through the opening 306 of the patch panel 302.

Embodiments of the patch panel 302 described herein are not limited to use with jacks 102 having the specific design depicted in FIGS. 8a-8c, and it is to be appreciated that patch panels 302 capable of accommodating other jack designs can incorporate the raised bump 310 described herein to establish electrical continuity between the patch panel 302 and the jack body.

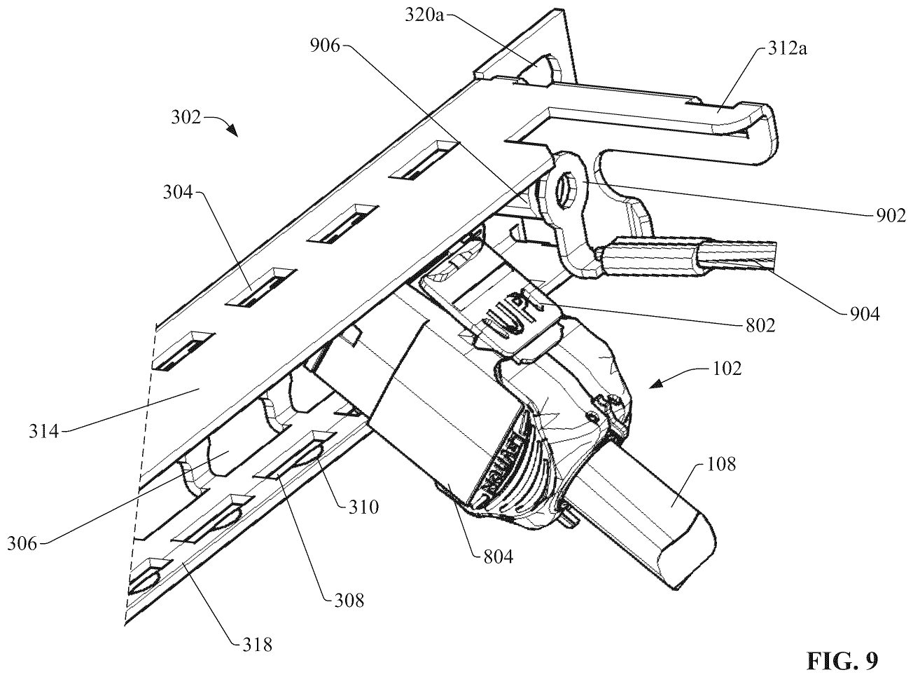

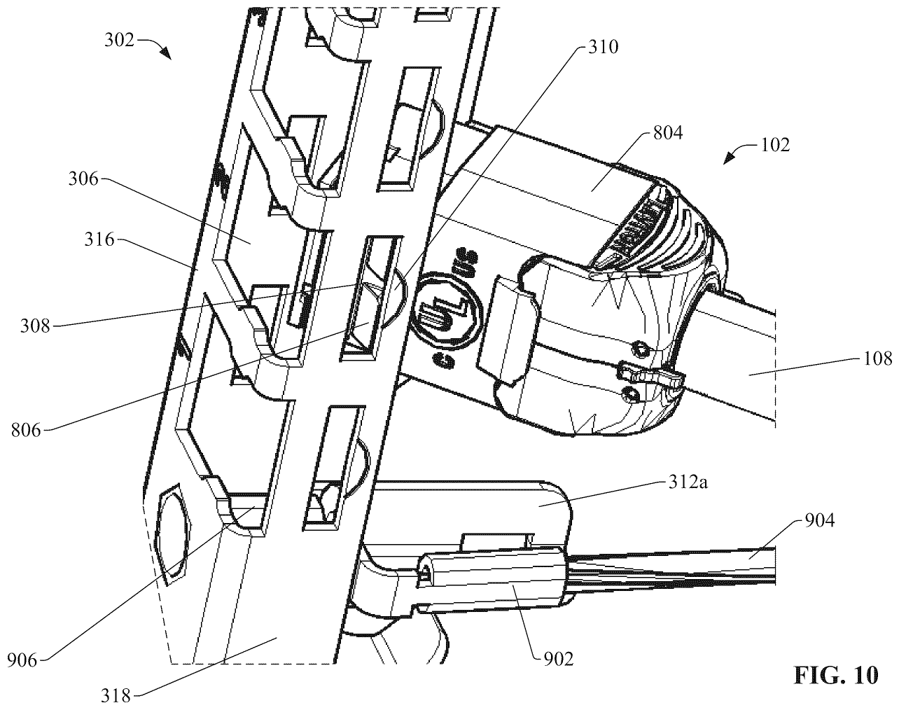

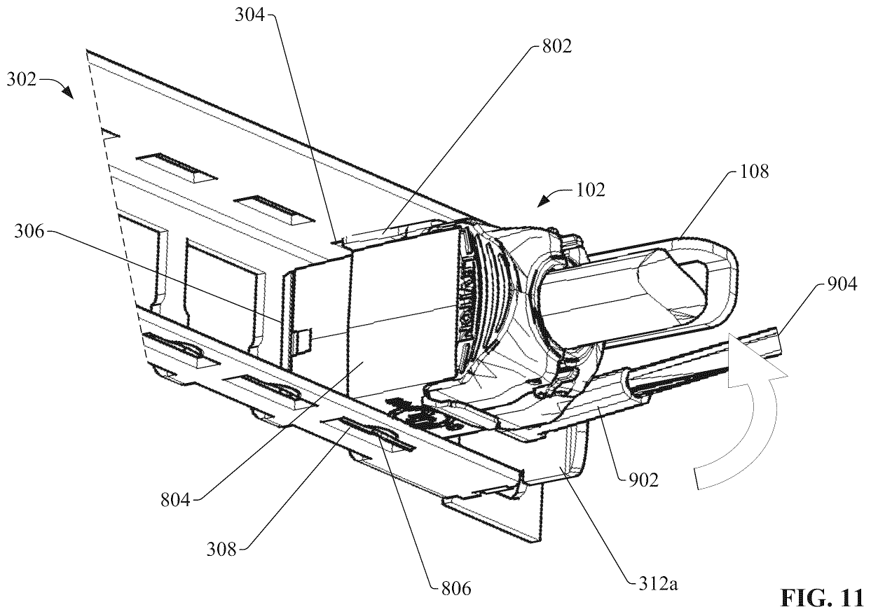

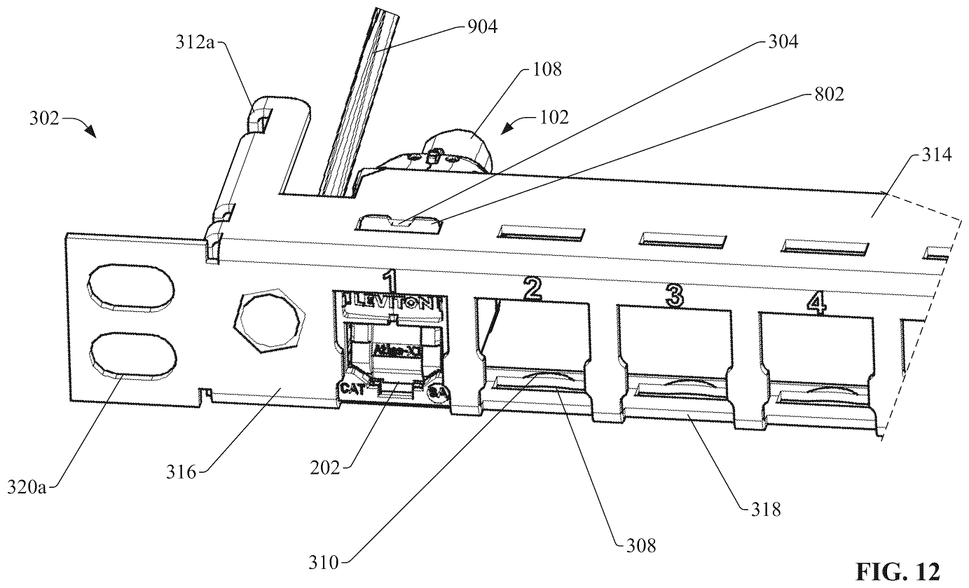

FIG. 9 is a perspective view of the patch panel 302 as seen from the rear of the patch panel 302 with a jack 102 oriented for installation into one of the patch panel's openings 306. FIG. 10 is another perspective view of the patch panel 302 with the jack 102 oriented for installation as seen from below the patch panel 302. As can be seen in FIG. 10, jack 102 can be installed in the opening 306 by initially inserting the jack's raised stops 806 into the lower slot 308 behind the opening 306 in which the jack 102 is to be installed, with the rear of the jack 102 angled downward. With the raised stops 806 engaged with the lower slot 308, the jack 102 can then be pivoted upward about the lower slot 308 until the latch 802 engages with the upper slot 304 located above the opening 306 as shown in FIG. 11, which is a perspective view of the patch panel 302 as seen from the rear of the patch panel 302 with the jack 102 fully installed in the opening 306. FIG. 12 is another perspective view of the patch panel 302 with the jack 102 fully installed as seen from the front of the patch panel 302.

While the jack 102 is installed as shown in FIGS. 11 and 12, the raised bump 310 (not visible under the jack 102 in FIGS. 11 and 12) makes robust contact with the bottom surface of the metal jack body 804. Since the raised bump 310 was masked during the painting or powder coat process, the contact between bare exposed metal of the raised bump 310 and the metal jack body 804 yields a reliable point of electrical continuity between the jack body 804 and the patch panel 302. If the drain wire of the data cable 108 is connected to the jack body 804 inside the jack 102, this also serves to ground the data cable's shielding via the patch panel 302. The patch panel 302 itself can be grounded via the any means suitable for the type of installation in which the patch panel 302 is used. For example, the patch panel 302 may be grounded via the metal framework of an equipment rack on which the patch panel 302 is installed, or via a grounded structure on an internal side of a wall on which the patch panel 302 is installed. As shown in FIGS. 9-12, some embodiments of the patch panel 302 can include a grounding stud 906 or another grounding feature formed on the rear side of the patch panel 302. A ground wire 904 can be connected to this grounding stud 906 using a ring terminal 902 or another type of termination, which yields electrical continuity between the metal frame of the patch panel 302 (and thus the raised bumps 310) and the ground wire 904. The opposite end of the ground wire 904 can be connected to a grounding structure (not shown) such as a rack, cabinet, or building grounding system, yielding a complete path to ground from the jack body 804 via the raised bump 310, the patch panel 302, and the ground wire 904.

To reduce the risk of metallic corrosion on the raised bumps 310 due to repeated connection and disconnection of the jacks 102, the patch panel 302 can be formed from sheet metal that has been pre-plated for corrosion resistance. Example plating materials that can be used to plate the patch panel 302 (and thus the raised bumps 310) for corrosion resistance can include, but are not limited to, nickel, tin, silver, or palladium.

The raised bumps 310 formed on embodiments of the patch panel 302 described herein can maintain robust paths of electrical conductivity between the patch panel 302 and the jacks 102 installed in the patch panel's openings 306 without using intermediate spring components that would otherwise be required to bridge the non-conductive gap between the jacks 102 and the patch panel 302 caused by the layer paint or powder coat on the patch panel 302. By eliminating these intermediate components, this design can reduce manufacturing cost, labor, and complexity without sacrificing robust electrical continuity between patch panel 302 and its associated jacks 102.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A patch panel, comprising:
a metal frame comprising a front face and a bottom ridge that extends rearward from a bottom edge of the front face;
an opening formed through the front face and configured to receive a data jack; and
a lower slot formed through the bottom ridge behind the opening,
wherein a raised bump is formed adjacent to the lower slot along a rear-facing long edge of the lower slot.

2. The patch panel of claim 1, wherein a surface of the raised bump comprises exposed metal.

3. The patch panel of claim 1 wherein
the metal frame comprises a layer of paint or powder coat, and
the raised bump is masked from a process that applies the paint or powder coat.

4. The patch panel of claim 1, wherein the lower slot is configured to engage with a raised stop formed on the data jack while the data jack is installed in the opening.

5. The patch panel of claim 1, wherein the raised bump is configured to contact a bottom side of the data jack while the data jack is installed in the opening.

6. The patch panel of claim 5, wherein contact between the bottom side of the data jack and the raised bump results in a conductive path between the data jack and the metal frame.

7. The patch panel of claim 1, wherein
the metal frame further comprises a ground stud, and
the contact between the bottom side of the data jack and the raised bump results in a conductive path between the data jack and the ground stud.

8. The patch panel of claim 1, wherein
the frame further comprises an upper ridge that extends rearward from a top edge of the front face,
an upper slot is formed through the upper ridge above the opening, and
the upper slot is configured to engage with a cantilevered latch on the data jack while the data jack is installed in the opening.

9. The patch panel of claim 1, wherein the raised bumps are plated with a corrosion-resistant material.

10. The patch panel of claim 9, wherein the corrosion-resistant material is at least one of nickel, tin, silver, or palladium.

11. A patch panel, comprising:
an opening formed through a front face of the patch panel and configured to receive a front side of a data jack;
a lower slot configured to engage with a raised stop on a bottom side of the data jack while the data jack is installed in the opening; and
a raised bump formed adjacent to the lower slot and configured to make contact with the bottom side of the data jack while the data jack is installed in the opening.

12. The patch panel of claim 11, wherein a surface of the raised bump is uncoated by paint or powder coat.

13. The patch panel of claim 11, wherein contact between the bottom side of the data jack and the raised bump yields an electrically conductive pathway between the data jack and the patch panel.

14. The patch panel of claim 13, further comprising a grounding feature configured to electrically interface the patch panel with a grounded structure,
wherein the contact between the bottom side of the data jack and the raised bump yields an electrically conductive pathway between the data jack and the grounding feature.

15. The patch panel of claim 11, further comprising a top slot configured to engage with a cantilevered latch on a top side of the data jack while the data jack is installed in the opening.

16. The patch panel of claim 11, wherein the raised bumps comprise a corrosion-resistant plating.

17. The patch panel of claim 16, wherein the corrosion-resistant plating comprises at least one of nickel, tin, silver, or palladium.

18. A patch panel, comprising:
a front face comprising an opening configured to receive a data jack; and
a bottom ridge comprising a lower slot and a raised bump located adjacent to the lower slot,
wherein the lower slot is configured to receive a raised stop formed on the data jack and the raised bump is configured to make contact with a casing of the data jack while the data jack is installed in the opening.

19. The patch panel of claim 18, wherein a surface of the raised bump comprises exposed metal.

20. The patch panel of claim 18, wherein a conductive path is established between the data jack and the patch panel in response to the casing of the data jack contacting the raised bump.
